(19) United States
(12) Patent Application Publication
(10) Pub. No.: US 2021/0276537 A1
(43) Pub. Date: Sep. 9, 2021

(54) DRIVE DEVICE FOR HYBRID VEHICLE

(71) Applicant: TOYOTA JIDOSHA KABUSHIKI KAISHA, Toyota-shi (JP)

(72) Inventors: Yoshio HASEGAWA, Chiryu-shi (JP); Takeshi AKIRA, Toyota-shi (JP)

(73) Assignee: TOYOTA JIDOSHA KABUSHIKI KAISHA, Toyota-shi (JP)

(21) Appl. No.: 17/190,943

(22) Filed: Mar. 3, 2021

(30) Foreign Application Priority Data
Mar. 5, 2020 (JP) 2020-038151

(51) Int. Cl. B60W 20/30; F16H 61/04; B60W 10/08; B60W 10/115

(52) U.S. Cl. CPC B60W 20/30; B60W 10/115; B60W 10/08; F16H 61/0437

(57) ABSTRACT

An ECU executes a first control when an automatic transmission has a shift range changed from an N range to a D range. In the first control, the ECU initially rotates an EOP and also sets a motor generator's rotational speed to a prescribed rotational speed. The ECU rapidly engages a Drive clutch while maintaining the motor generator's rotational speed at the prescribed rotational speed. The ECU then increases the motor generator's rotational speed to a target rotational speed set for the D range.

This nonprovisional application is based on Japanese Patent Application No. 2020-038151 filed on Mar. 5, 2020 with the Japan Patent Office, the entire contents of which are hereby incorporated by reference.

### BACKGROUND

### Field

The present disclosure relates to a drive device for a hybrid vehicle.

### Description of the Background Art

Japanese Patent Laid-Open No. 2015-217914 discloses a hybrid vehicle comprising an engine, a motor generator, a K0 clutch provided between the engine and the motor generator, and an automatic transmission that transmits power of at least one of the engine and the motor generator to a driving wheel. In the hybrid vehicle, when the automatic transmission has a shift range changed, an engagement element included in the automatic transmission has an engagement state switched to form a shift range applied after the previous shift range is changed.

### SUMMARY

In the hybrid vehicle disclosed in Japanese Patent Laid-Open No. 2015-217914, no consideration is given to the rotational speed of the input shaft of the automatic transmission when the engagement element included in the automatic transmission has an engagement state switched. When the automatic transmission has its input shaft rotated and the engagement element included in the automatic transmission has an engagement state switched, there is a possibility that an inertia torque is generated and a shift shock occurs. While the shift shock may be relaxed by gradually changing a hydraulic pressure supplied to the engagement element included in the automatic transmission, and thus switching the engagement state of the engagement element, doing so would impair responsiveness of gear shifting.

The present disclosure has been made in order to address the above issue, and an object of the present disclosure is to suppress occurrence of a shift shock in a hybrid vehicle comprising an engine, a motor generator, an engagement element provided between the engine and the motor generator, and an automatic transmission, while ensuring responsiveness of changing a shift range of the automatic transmission.

(1) A drive device for a hybrid vehicle according to the present disclosure comprises: an internal combustion engine; an electric motor; an automatic transmission that transmits power of at least one of the internal combustion engine and the electric motor to a driving wheel; a first engagement element provided between the internal combustion engine and the electric motor; an electrically driven hydraulic pressure source that supplies hydraulic pressure to the first engagement element and engagement elements included in the automatic transmission; and a control device that controls the electric motor and the electrically driven hydraulic pressure source. When the automatic transmission has a shift range changed and the first engagement element is disengaged, the control device executes a prescribed control. In the prescribed control, the control device sets a rotational speed of the electric motor to be equal to or lower than a prescribed rotational speed, switches an engagement state of the engagement elements included in the automatic transmission to an engagement state corresponding to the changed shift range, and increases the rotational speed of the electric motor to a target rotational speed corresponding to the changed shift range.

According to the above configuration, when the automatic transmission has a shift range changed and the first engagement element is disengaged, the engagement elements included in the automatic transmission have an engagement state switched while the electric motor rotates at a speed equal to or lower than a prescribed rotational speed. The prescribed rotational speed is set for example such that a shift shock of an extent making an occupant of the hybrid vehicle feel discomfort is not caused even when hydraulic pressure supplied to the engagement elements included in the automatic transmission is not gradually changed and is instead changed at once to engage and disengage the engagement elements. Thus, the hydraulic pressure applied to the engagement elements included in the automatic transmission can be changed at once while a shift shock is suppressed, and occurrence of the shift shock can be suppressed while responsiveness of changing a shift range of the automatic transmission is ensured.

(2) In an embodiment, the control device stops the electric motor when the shift range of the automatic transmission is a neutral range or a parking range. When the shift range of the automatic transmission is changed from the neutral range or the parking range to a forward drive range or a reverse drive range and the first engagement element is disengaged, the control device executes a first control as the prescribed control. In the first control, the control device continues to stop the electric motor, switches an engagement state of the engagement elements included in the automatic transmission to an engagement state corresponding to the changed shift range, and increases a rotational speed of the electric motor to the target rotational speed.

According to the above configuration, when a shift range is changed from the neutral range or the parking range to the forward drive range or the reverse drive range, the engagement elements included in the automatic transmission have an engagement state switched while the electric motor is stopped, that is, while the input shaft of the automatic transmission is not rotated. This can further relax a shift shock than when the engagement elements included in the automatic transmission have an engagement state switched while the electric motor rotates at a prescribed rotational speed. Further, when the shift range is the neutral range or the parking range, the electric motor can be stopped to save energy consumption.

(3) In an embodiment, the drive device for the hybrid vehicle further comprises a mechanically driven hydraulic pressure source that operates using the internal combustion engine or the electric motor as a power source. The control device stops the electric motor when the shift range of the automatic transmission is the neutral range or the parking range. The control device executes a first control as the prescribed control when the shift range of the automatic transmission is changed from the neutral range or the parking range to the forward drive range or the reverse drive range and the first engagement element is disengaged. In the first control, the control device increases a rotational speed of the electric motor to the prescribed rotational speed, switches an engagement state of the engagement elements included in the automatic transmission to an engagement state corresponding to the changed shift range, and increases the rotational speed of the electric motor to the target rotational speed.

When the electrically driven hydraulic pressure source is alone actuated, it may not be able to appropriately supply hydraulic pressure for switching an engagement state of the engagement elements included in the automatic transmission. According to the above configuration, under the first control, the electric motor's rotational speed is increased to a prescribed rotational speed to actuate the mechanically driven hydraulic pressure source. By operating the electrically driven hydraulic pressure source and the mechanically driven hydraulic pressure source, hydraulic pressure for switching the engagement state of the engagement elements included in the automatic transmission can be appropriately supplied.

(4) in an embodiment, the control device does not execute the first control when the shift range of the automatic transmission is changed from the neutral range or the parking range to the forward drive range or the reverse drive range and the first engagement element is not disengaged.

When the first engagement element is not disengaged, the input shaft of the automatic transmission rotates as the internal combustion engine operates. Therefore, even if the first control is executed, it cannot suppress a shift shock appropriately. According to the above configuration, when the first control cannot be executed to appropriately suppress the shift shock, executing the first control can be refrained from.

(5) In an embodiment, when the shift range of the automatic transmission is the forward drive range or the reverse drive range and an accelerator pedal is not operated, the control device causes the electric motor to rotate at a target rotational speed corresponding to the selected shift range. When the shift range of the automatic transmission is changed between the forward drive range and the reverse drive range and the first engagement element is disengaged, the control device executes a second control as the prescribed control. In the second control, the control device reduces the rotational speed of the electric motor to the prescribed rotational speed, switches an engagement state of the engagement elements included in the automatic transmission to an engagement state corresponding to the changed shift range, and increases the rotational speed of the electric motor to the target rotational speed.

According to the above configuration, when the shift range is the forward drive range or the reverse drive range and the accelerator pedal is not operated, the electric motor is rotated at a target rotational speed corresponding to the selected shift range (that is, a rotational speed at which a desired creep torque is generated). When the shift range is changed between the forward drive range and the reverse drive range and the first engagement element is disengaged, the rotational speed of the electric motor is decreased to a prescribed rotational speed, and in that condition, the engagement elements included in the automatic transmission have an engagement state switched. This can change hydraulic pressure at once and engage and disengage the engagement elements of the automatic transmission, and occurrence of a shift shock can be suppressed while responsiveness of changing a shift range of the automatic transmission is ensured.

(6) In an embodiment, the control device does not execute the second control when the shift range of the automatic transmission is changed between the forward drive range and the reverse drive range and the first engagement element is not disengaged.

When the first engagement element is not disengaged, the input shaft of the automatic transmission rotates as the internal combustion engine operates. Therefore, even if the second control is executed, it cannot suppress a shift shock appropriately. According to the above configuration, when the second control cannot be executed to appropriately suppress the shift shock, executing the second control can be refrained from.

(7) In an embodiment, the control device does not execute the second control when the hybrid vehicle has a vehicular speed larger than a threshold value.

Some driver may switch a shift range to another in a state before the hybrid vehicle is completely stopped. When the hybrid vehicle is traveling at a vehicular speed equal to or faster than a threshold value, and the electric motor has a rotational speed decreased to a prescribed rotational speed, a shock may be caused as the rotational speed is changed. According to the above configuration, when there is a possibility that a shock may be caused by executing the second control, executing the second control can be refrained from.

(8) In one embodiment, when the shift range of the automatic transmission is changed, the first engagement element is disengaged, and the internal combustion engine is actuated after the shift range is changed, the control device sets a rotational speed of the electric motor to be equal to or lower than a prescribed rotational speed, engages the first engagement element, switches an engagement state of the engagement elements included in the automatic transmission to an engagement state corresponding to the changed shift range, and increases the rotational speed of the electric motor to a target rotational speed corresponding to the changed shift range.

For example, some driver may depress the accelerator pedal at the same time as a shift range is changed. Depending on the amount by which the accelerator pedal is depressed, it may be necessary to actuate the internal combustion engine. In such a case, the first engagement element is engaged while the electric motor is rotating at a speed equal to or lower than a prescribed rotational speed. As the electric motor rotates at the speed equal to or lower than the prescribed rotational speed, the input shaft of the automatic transmission rotates at a suppressed speed. This can suppress occurrence of a shock even if the first engagement element is supplied with an engaging hydraulic pressure at once and thus engaged. Thus, the internal combustion engine can be actuated quickly.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 generally shows a configuration of a hybrid vehicle according to an embodiment.

FIG. 2 is a table for illustrating combinations of engagement elements of an automatic transmission of a hybrid vehicle when the hybrid vehicle is driven forward and reversed.

FIG. 3 is a diagram for illustrating a configuration of a hydraulic circuit.

FIG. 4 is timing plots for illustrating a first control.

FIG. 5 is timing plots for illustrating a second control.

FIG. 6 is a functional block diagram of an ECU.

FIG. 7 is a flowchart of a procedure of a process of the first control.

FIG. 8 is a flowchart of a procedure of a process of the second control.

FIG. 9 is a flowchart of a procedure of a process of the first control in a variation.

FIG. 10 is a flowchart of a procedure of a process of the second control in a variation.

### DESCRIPTION OF THE PREFERRED EMBODIMENTS

Hereinafter, embodiments of the present disclosure will be described in detail with reference to the drawings. In the drawings, identical or equivalent components are identically denoted and will not be described redundantly.

<General Configuration>

FIG. 1 generally shows a configuration of a hybrid vehicle 1 according to an embodiment. Hybrid vehicle 1 includes an engine 10, a K0 clutch 12, a motor generator 22, an automatic transmission 23, a torque converter 24, a hydraulic circuit 26, an electric oil pump (hereinafter also referred to as an “EOP”) 27, a mechanical oil pump (hereinafter also referred to as an “MOP”) 28, a power control unit (PCU) 40, a battery 42, a driving wheel 72, and an electronic control unit (ECU) 100. Hybrid vehicle 1 according to the present embodiment has at least an HV mode and an EV mode as travelling modes. The HV mode is a traveling mode using engine 10 and motor generator 22 as power sources. The EV mode is a traveling mode in which engine 10 is stopped and motor generator 22 is driven by the electric power of battery 42 to cause the vehicle to travel. A traveling mode is selected based for example on power required for hybrid vehicle 1.

Engine 10 is for example an internal combustion engine such as a gasoline engine or a diesel engine. Engine 10 is controlled by a control signal issued from ECU 100.

Motor generator 22 is an alternating-current rotating electrical machine, and it is for example a three-phase alternating-current rotating electrical machine having a permanent magnet embedded in a rotor (not shown). Motor generator 22 has a rotary shaft coupled with a crankshaft of engine 10 via K0 clutch 12. Motor generator 22 rotates the crankshaft of engine 10 using the electric power of battery 42 in starting engine 10. Motor generator 22 can also generate electric power using the power of engine 10. Motor generator 22 generates AC power which is in turn converted to DC power by PCU 40 and charged in battery 42. Motor generator 22 also has the rotary shaft coupled with the input shaft of torque converter 24.

Torque converter 24 includes a pump impeller 24a coupled with the rotary shaft of motor generator 22, a turbine impeller 24b coupled with the input shaft of automatic transmission 23, and a stator 24c provided between pump impeller 24a and turbine impeller 24b. The input and output shafts of torque converter 24 rotate in synchronization when a lock-up clutch (not shown) is engaged, and rotate out of synchronization when the lock-up clutch is disengaged.

Automatic transmission 23 is a stepped automatic transmission that shifts a plurality of gears sequentially. Automatic transmission 23 has a plurality of shift ranges. The plurality of shift ranges include, for example, a forward drive range (hereinafter also referred to as “D range”), a reverse drive range (hereinafter also referred to as “R range”), a parking range (hereinafter also referred to as “P range”), and a neutral range (hereinafter also referred to as “N range”). When the D range is selected as a shift range, one of the first gear to the top gear is formed depending on how hybrid vehicle 1 is driven.

Automatic transmission 23 includes, for example, a transmission unit including one or more planetary gear mechanisms, and a plurality of engagement elements. The plurality of engagement elements includes a brake for stopping rotation of a rotative element of a planetary gear mechanism, and a clutch for synchronizing rotation with another rotative element. In the present embodiment, automatic transmission 23 includes a C1 clutch 14, a C2 clutch 15, a C3 clutch 16, a C4 clutch 17, a B1 brake 18, and a B2 brake 19. In the fallowing description, C1 clutch 14, C2 clutch 15, C3 clutch 16, C4 clutch 17, B1 brake 18, and B2 brake 19 will also be collectively referred to as an “AT clutch,” Of the AT clutch, any engagement element engaged when forming the D range will also be collectively referred to as a “Drive clutch.” Of the AT clutch, any engagement element engaged when forming the R range will also be collectively referred to as a “Rev clutch.”

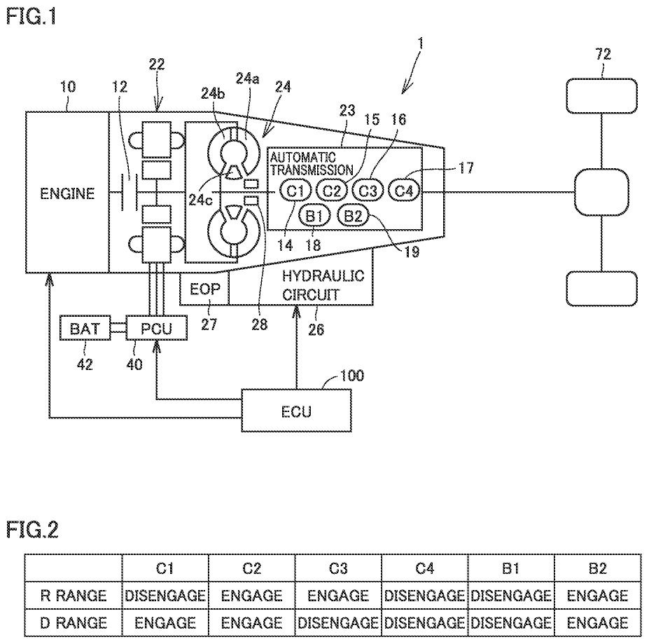

FIG. 2 is a table for illustrating combinations of the engagement elements of automatic transmission 23 of hybrid vehicle 1 when the hybrid vehicle is driven forward and reversed.

Referring to FIG. 2, in the present embodiment, when hybrid vehicle 1 is driven forward (that is, when the D range is selected and the first gear is formed as the current gear), C1 clutch 14, C2 clutch 15 and B2 brake 19 are engaged. That is, the forward driving first gear is formed by engaging C1 clutch 14, C2 clutch 15, and B2 brake 19. C1 clutch 14, C2 clutch 15, and B2 brake 19 are collectively referred to as the Drive clutch, C3 clutch 16, C4 clutch 17, and B1 brake 18 are disengaged.

When hybrid vehicle 1 is reversed (that is, when the R range is selected), C2 clutch 15, C3 clutch 16, and B2 brake 19 are engaged. That is, a reverse gear is formed by engaging C2 clutch 15, C3 clutch 16, and B2 brake 19. C2 clutch 15, C3 clutch 16, and B2 brake 19 are collectively referred to as the Rev clutch. C1 clutch 14, C4 clutch 17, and B1 brake 18 are disengaged.

Although not shown in FIG. 2, any gear for the D range other than the first gear second and third gears) is also formed by combinations of engaging and disengaging C1 clutch 14, C2 clutch 15, C3 clutch 16, C4 clutch 17, B1 brake 18, and B2 brake 19.

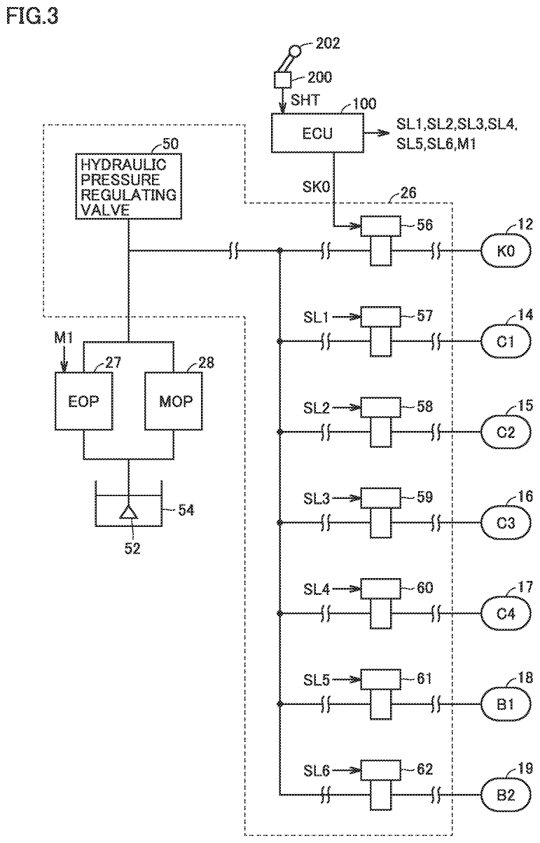

Referring again to FIG. 1, EOP 27 operates using as a power source a motor (not shown) that operates in response to a control signal received from ECU 100. The motor is driven by using electric power of battery 42 or an auxiliary battery (not shown). MOP 28 operates as pump impeller 24a rotates with engine 10 or motor generator 22 serving as a power source. EOP 27 and MOP 28 both supply hydraulic circuit 26 with hydraulic oil reserved in an oil pan 54 (see FIG. 3).

Hydraulic circuit 26 operates in response to a control signal received from ECU 100 to supply hydraulic oil to at least one of K0 clutch 12 and the AT clutch (C1 clutch 14, C2 clutch 15, C3 clutch 16, C4 clutch 17, B1 brake 18, and B2 brake 19).

K0 clutch 12, C1 clutch 14, C2 clutch 15, C3 clutch 16, C4 clutch 17, B1 brake 18, and B2 brake 19 each have two rotative bodies (a driving plate and a driven plate provided with a friction material) for receiving and passing power. When the hydraulic oil is received, the hydraulic pressure corresponding to the amount of the hydraulic oil received moves a clutch piston, and friction is thus caused between the two rotative bodies. This allows a force to act so that the two rotative bodies no longer rotate relative to each other, and K0 clutch 12, C1 clutch 14, C2 clutch 15, C3 clutch 16, C4 clutch 17, B1 brake 18, and B2 brake 19 are each engaged (that is, the two rotative bodies rotate synchronously).

ECU 100 includes a central processing unit (CPU), a memory (RAM (Random Access Memory) and ROM (Read Only Memory)), and an input/output buffer for inputting/outputting various signals (all not shown). The CPU loads a program stored in the ROM into the RAM and executes the program. The program stored in the ROM describes a process executed by the CPU. ECU 100 performs a prescribed computation by the CPU based on various signals received from the input/output buffer and information stored in the memory, and controls each component (engine 10, PCU 16, hydraulic circuit 26, etc.) based on the computational result so that hybrid vehicle 1 achieves a desired state. Note that these controls are not limited to processing done by software and may be constructed and thus processed by dedicated hardware (or electronic circuitry).

ECU 100 sets a shift range in accordance with a shift position selected by the driver's shift lever operation (see FIG. 3). ECU 100 switches the AT clutch's engagement state (engagement and disengagement) to form the set shift range. Specifically, ECU 100 controls hydraulic circuit 26 to engage or disengage C1 clutch 14, C2 clutch 15, C3 clutch 16, C4 clutch 17, B1 brake 18, and B2 brake 19 to form the set shift range.

ECU 100 determines whether it is necessary to actuate engine 10, When the N range and the P range are selected as the current shift range, ECU 100 determines whether it is necessary to actuate engine 10 based on the state of charge (SOC) of battery 42, For example, when battery 42 has an SOC less than a prescribed SOC, ECU 100 actuates engine 10 to cause motor generator 22 to generate electric power using the power of engine 10. ECU 100 charges battery 42 with the electric power generated by motor generator 22. On the other hand, when battery 42 has an SOC equal to or larger than the prescribed SOC, ECU 100 stops engine 10, When ECU 100 stops engine 10, ECU 100 controls hydraulic circuit 26 to disengage K0 clutch 12. When hybrid vehicle 1 is provided with a mode, such as a towing mode, in which engine 10 is constantly operated, ECU 100 may determine whether it is necessary to actuate engine 10 depending on whether the mode is on or off.

When the D range is selected as the current shift range, ECU 100 determines whether it is necessary to actuate engine 10 depending on how hybrid vehicle 1 is driven. ECU 100 calculates power required for hybrid vehicle 1 (required power) based for example on the amount by which the accelerator pedal (not shown) is depressed and the speed of hybrid vehicle 1. ECU 100 requests actuating engine 10 for example when the required power exceeds a threshold value. ECU 100 requests stopping engine 10 for example when the required power is below the threshold value.

A configuration of hydraulic circuit 26 will now be described. FIG. 3 is a diagram for illustrating a configuration of hydraulic circuit 26. Hydraulic circuit 26 includes a hydraulic pressure regulating valve 50, a zeroth solenoid valve 56, a first solenoid valve 57, a second solenoid valve 58, a third solenoid valve 59, a fourth solenoid valve 60, a fifth solenoid valve 61, and a sixth solenoid valve 62.

When at least one of EOP 27 and MOP 28 is actuated, the hydraulic oil reserved in oil pan 54 is sucked through a strainer 52 and discharged to hydraulic circuit 26. EOP 27 operates in response to a control signal M1 received from ECU 100.

Hydraulic pressure regulating valve 50 regulates the hydraulic pressure of the hydraulic oil discharged from at least one of EOP 27 and MOP 28 to be a prescribed hydraulic pressure (a line pressure).

Zeroth solenoid valve 56, first solenoid valve 57, second solenoid valve 58, third solenoid valve 59, fourth solenoid valve 60, fifth solenoid valve 61, and sixth solenoid valve 62 each receive the hydraulic pressure regulated by hydraulic pressure regulating valve 50.

Zeroth solenoid valve 56 receives the hydraulic pressure that has been regulated by hydraulic pressure regulating valve 50 as an initial pressure, and regulates it to supply K0 clutch 12 with a pressure indicated based on a control signal. SKO issued from ECU 100.

First solenoid valve 57 receives the hydraulic pressure that has been regulated by hydraulic pressure regulating valve 50 as an initial pressure, and regulates it to supply C1 clutch 14 with a pressure indicated based on a control signal SL1 issued from ECU 100.

Second solenoid valve 58 receives the hydraulic pressure that has been regulated by hydraulic pressure regulating valve 50 as an initial pressure, and regulates it to supply C2 clutch 15 with a pressure indicated based on a control signal SL2 issued from ECU 100.

Third solenoid valve 59 receives the hydraulic pressure that has been regulated by hydraulic pressure regulating valve 50 as an initial pressure, and regulates it to supply C3 clutch 16 with a pressure indicated based on a control signal SL3 issued from ECU 100.

Fourth solenoid valve 60 receives the hydraulic pressure that has been regulated by hydraulic pressure regulating valve 50 as an initial pressure, and regulates it to supply C4 clutch 17 with a pressure indicated based on a control signal SL4 issued from ECU 100.

Fifth solenoid valve 61 receives the hydraulic pressure that has been regulated by hydraulic pressure regulating valve 50 as an initial pressure, and regulates it to supply B1 brake 18 with a pressure indicated based on a control signal SL5 issued from ECU 100.

Sixth solenoid valve 62 receives the hydraulic pressure that has been regulated by hydraulic pressure regulating valve 50 as an initial pressure, and regulates it to supply B2 brake 19 with a pressure indicated based on a control signal SL6 issued from ECU 100.

A shift position sensor 200 that detects the position of a shift lever 202 is connected to ECU 100. Shift position sensor 200 detects the position of shift lever 202 and transmits to ECU 100 a signal SHT indicating a result of the detection.

ECU 100 receives signal SHT from shift position sensor 200 and identifies therefrom a shift range selected by the driver. For example, when the driver moves shift lever 202 to a position corresponding to the D range, shift position sensor 200 transmits signal SHT corresponding to the D range to ECU 100. Based on signal SHT received from shift position sensor 200, ECU 100 determines that the driver has selected the D range for the current shift range.

In hybrid vehicle 1 having the above-described configuration, when a shift range is changed, ECU 100 switches an engagement state of the AT clutch of automatic transmission 23 according to the changed shift range. In this case, if the engagement state of the AT clutch is switched while the input shaft of automatic transmission 23 is rotating, there is a possibility that an inertia torque may be generated and a shift shock may be caused. While the shift shock may be relaxed by gradually changing the hydraulic pressure supplied to the AT clutch to switch the engagement state of the AT clutch, doing so would impair responsiveness of gear shifting. In particular, in a case where gears are shifted and simultaneously the accelerator pedal is depressed, and actuating engine 10 is required, responsiveness of gear shifting is a more significant issue. Specifically, in the above-described case, for example, after gears have been shifted, K0 clutch 12 is engaged and engine 10 is started, Therefore, if responsiveness of gear shifting is low, it takes time to start the engine after the driver depresses the accelerator pedal, and there is a possibility that the driver may feel hesitation. Accordingly, it is desired to complete gear-shifting early. In the following description, changing a hydraulic pressure that is supplied to an engagement element from a disengaging hydraulic pressure (a MIN pressure) to an engaging hydraulic pressure (a MAX pressure) at once to engage the engagement element will also be referred to as “rapid engagement.” Furthermore, in the following description, changing a hydraulic pressure that is supplied to an engagement element from the engaging hydraulic pressure (the MAX pressure) to the disengaging hydraulic pressure (the MIN pressure) at once to disengage the engagement element will also be referred to as “rapid disengagement.”

The present inventors have conceived reducing a shift shock by switching an engagement state of the AT clutch while the input shaft of automatic transmission 23 rotates at a speed equal to or lower than a first rotational speed. The first rotational speed is a rotational speed at which a shift shock of an extent making an occupant of hybrid vehicle 1 feel discomfort is not caused even when the AT clutch is rapidly engaged.

When the traveling mode of hybrid vehicle 1 is the EV mode, engine 10 is stopped and K0 clutch 12 is disengaged, Therefore, the rotational speed of the input shaft of automatic transmission 23 is determined based on the rotational speed of motor generator 22. When the rotational speed of motor generator 22 is controlled to set the rotational speed of the input shaft of automatic transmission 23 to a rotational speed equal to or lower than the first rotational speed, occurrence of a shift shock can be suppressed even when the AT clutch is rapidly disengaged and rapidly engaged. Therefore, it is unnecessary to gradually change a hydraulic pressure supplied to the AT clutch, which ensures responsiveness of gear shifting. In the present embodiment, when the traveling mode of hybrid vehicle 1 is the EV mode, ECU 100 executes first control or second control depending on the pattern of changing a shift range to another. Hereinafter, the first control and the second control will be described with reference to the shift range changing pattern.

Note that when the traveling mode of hybrid vehicle 1 is not the EV mode (in the present embodiment, the HV mode), K0 clutch 12 is engaged and engine 10 is actuated. Therefore, it is assumed that the input shaft of automatic transmission 23 rotates at a speed higher than the first rotational speed. Therefore, when the traveling mode of hybrid vehicle 1 is not the EV mode, ECU 100 gradually changes a hydraulic pressure supplied to the AT clutch and thus switches an engagement state of the AT clutch to execute “normal control.”

<First Control>

The first control is executed by ECU 100 when gears are shifted in a first shift pattern. The first shift pattern includes a shift from the N range to the D range, a shift from the N range to the R range, a shift from the P range to the D range, and a shift from the P range to the R range. Hereinafter, the first control will be described by referring as an example to a case where a shift from the N range to the D range is made as a representative of the first shift pattern. Note that the same idea as described below is also applicable to shifts in the first shift pattern other than the shift from the N range to the D range.

In the N range and the P range, whether engine 10 should be actuated is determined based on the SOC of battery 42, as has been described above. To facilitate understanding, the following description will be provided assuming that battery 42 has an SOC equal to or larger than a prescribed SOC. That is, when the N range or the P range is selected, ECU 100 stops engine 10 and disengages K0 clutch 12. In other words, when the N range or the P range is selected, ECU 100 selects the EV mode as the traveling mode.

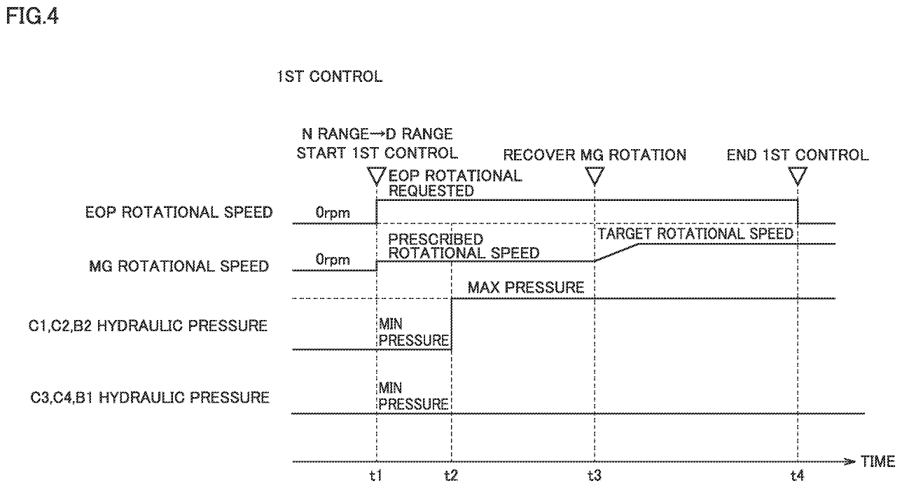

FIG. 4 is timing plots for illustrating the first control. In FIG. 4, the axis of abscissas represents time. In FIG. 4, the axis of ordinates represents rotational speed of EOP 27, rotational speed of motor generator 22 (MG rotational speed), and hydraulic pressure supplied to the AT clutch.

Referring to FIG. 4, the current shift range is changed from the N range to the D range at time t1 for the sake of illustration Before time t1, the shift range is the N range, and accordingly, engine 10, motor generator 22 and EOP 27 are stopped. K0 clutch 12 and the AT clutch are disengaged. In the present embodiment, when the shift range is the N range or the P range, motor generator 22 is stopped, and accordingly, MOP 28 is also stopped. When the shift range is the N range or the P range, motor generator 22 can be stopped to suppress energy consumption. When the shift range is the N range or the P range, EOP 27 is stopped. This can maintain durability of EOP 27.

At time t1, ECU 100 determines that the shift range has been changed from the N range to the D range, and accordingly, ECU 100 starts the first control. In the first control, ECU 100 initially drives a motor to rotate EOP 27 in order to supply the AT clutch with hydraulic pressure.

Further, at time t1, ECU 100 actuates and controls motor generator 22 to operate at a prescribed rotational speed lower than a target rotational speed set for motor generator 22 for the D range. The target rotational speed is, for example, a rotational speed of motor generator 22 for generating a desired creep torque in the D range. It is also possible to set different values for the target rotational speed in the D range and the R range. The prescribed rotational speed is a rotational speed for setting the rotational speed of the input shaft of automatic transmission 23 to the first rotational speed. In other words, the prescribed rotational speed is a rotational speed at which a shift shock caused by rapid engagement of the AT clutch is suppressed to an extent which does not make an occupant of hybrid vehicle 1 feel discomfort. The prescribed rotational speed can be appropriately set based on experiments, simulations, the specification of hybrid vehicle 1, and the like. Herein, motor generator 22 is actuated in order to actuate MOP 28, When EOP 27 is alone actuated, it may not be able to appropriately supply hydraulic pressure required for switching the engagement state of the AT clutch. By actuating MOP 28 in addition to EOP 27, the hydraulic pressure required for switching the engagement state of the AT clutch can be appropriately supplied.

At time t2, ECU 100 rapidly engages the Drive clutch while maintaining the rotational speed of motor generator 22 at the prescribed rotational speed. A period of time from time t1 to time t2 is set for example to a period of time equal to or longer than that elapsing before EOP 27 and MOP 28 can operate properly.

At time t3, ECU 100 increases the rotational speed of motor generator 22 to the target rotational speed. A period of time from time t2 to time t3 is set for example to a period of time equal to or longer than that required after the hydraulic pressure is supplied before the Drive clutch is completely engaged.

At time t4, ECU 100 ends the first control. Specifically, ECU 100 stops EOP 27 while maintaining the rotational speed of motor generator 22 at the target rotational speed.

Thus, under the first control, the AT clutch has an engagement state switched while motor generator 22 rotates at a prescribed speed. Since motor generator 22 rotates at a low speed, occurrence of a shift shock can be suppressed even when the AT clutch is rapidly engaged and disengaged. Under the first control, the AT clutch can be rapidly engaged and disengaged, and when this is compared with a case where the AT clutch is engaged and disengaged while hydraulic pressure supplied to the AT clutch is gradually changed in order to suppress occurrence of a shift shock (i.e., normal control), the former can reduce a period of time required for shifting gears. It should be noted that MOP 28 may not be actuated when EOP 27 can be actuated to sufficiently supply hydraulic circuit 26 with hydraulic oil for switching an engagement state of the AT clutch. In that case, motor generator 22 can be stopped until time t3, Therefore, the engagement state of the AT clutch can be switched in a state where motor generator 22 has a rotational speed of zero, that is, the input shaft of automatic transmission 23 is not rotating. Therefore, a shift shock can be further reduced as compared with a case where an engagement state of the AT clutch is switched in a state where motor generator 22 rotates at a prescribed rotational speed.

<Second Control>

The second control is executed by ECU 1.00 when gears are shifted in the second shift pattern. The second shift pattern includes a shift from the D range to the R range and a shift from the R range to the D range, Hereinafter, the second control will be described by referring as a representative example of the second shift pattern to a case where a shift is made from the R range to the D range. The same idea as described below is also applicable to the shift from the D range to the R range,

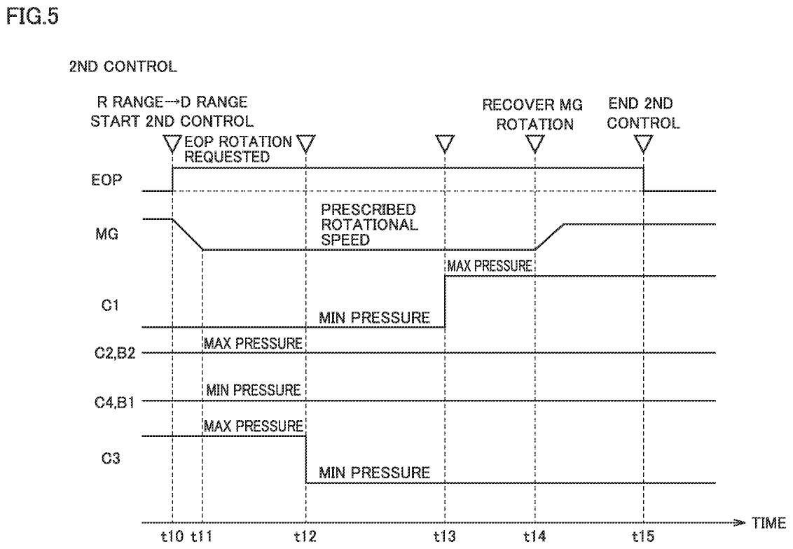

FIG. 5 is timing plots for illustrating the second control. In FIG. 5, the axis of abscissas of represents time. In FIG. 5, the axis of ordinates represents rotational speed of EOP 27, rotational speed of motor generator 22, and hydraulic pressure supplied to the AT clutch.

Referring to FIG. 5, the current shift range is changed from the R range to the D range at time t10 for the sake of illustration. Before time t10, hybrid vehicle 1 is reversed in the R range at an extremely low speed by a creep torque. Motor generator 22 is rotating at a target rotational speed in the R range. At time t11, the current shift range is changed from the R range to the D range. Note that in this case it is assumed that there is no operation by the driver to operate the accelerator pedal or there is no operation to operate the accelerator pedal that requires engine 10 to be actuated.

At time t10, ECU 100 determines that the current shift range has been changed from the R range to the D range, and ECU 100 starts the second control. When the second control is started, ECU 100 initially reduces the rotational speed of motor generator 22 to a prescribed rotational speed. Further, in order to allow hydraulic pressure to be supplied to the AT clutch, ECU 100 drives a motor to rotate EOP 27.

At time t11, the rotational speed of motor generator 22 decreases to the prescribed rotational speed.

At time t12, ECU 100 disengages a Rev clutch to be disengaged in order to form the D range, i.e., C3 clutch 16. As can be seen from FIG. 5, C3 clutch 16 is disengaged while the rotational speed of motor generator 22 is reduced to the prescribed rotational speed. A period of time from time t1l to time t12 is set for example to be equal to or longer than a period of time elapsing after a control signal for actuating EOP 27 is transmitted before EOP 27 can supply a line pressure.

At time t13, ECU 100 engages a Drive clutch that is not engaged, or C1 clutch 14, As can be seen from FIG. 5, C1 clutch 14 is engaged while the rotational speed of motor generator 22 is reduced to the prescribed rotational speed. A period of time from time t12 to time t13 is set for example to be equal to or longer than a period of time required after the hydraulic pressure is set to the MIN pressure before C3 clutch 16 is completely disengaged.

At time t14, ECU 100 increases the rotational speed of motor generator 22 from the prescribed rotational speed to a target rotational speed set for the D range. A period of time from time t13 to time t14 is set for example to be equal to or longer than a period of time required after the hydraulic pressure is set to the MAX pressure before C1 clutch 14 is completely engaged.

At time t15. ECU 100 ends the second control. Specifically, ECU 100 stops EOP 27 while maintaining the rotational speed of motor generator 22 at the target rotational speed set for the D range.

Thus, under the second control, motor generator 22 has a rotational speed reduced to a prescribed rotational speed, and the AT clutch has an engagement state switched while motor generator 22 rotates at a low speed. Since motor generator 22 rotates at a low speed, occurrence of a shift shock can be suppressed even when the Rev clutch is rapidly disengaged and the Drive clutch is rapidly engaged. Under the second control, the AT clutch can be rapidly engaged and disengaged, and when this is compared with a case where the AT clutch is engaged and disengaged while hydraulic pressure supplied to the AT clutch is gradually changed in order to suppress occurrence of a shift shock, the former can reduce a period of time required for shifting gears.

Note that changing a shift range from the D range to the R range is different from doing so from the R range to the D range in that for the former, C1 clutch 14 is disengaged at time t12 and C3 clutch 16 is engaged at time t13. The remainder is the same as shifting from the R range to the D range.

<Functional Block of ECU>

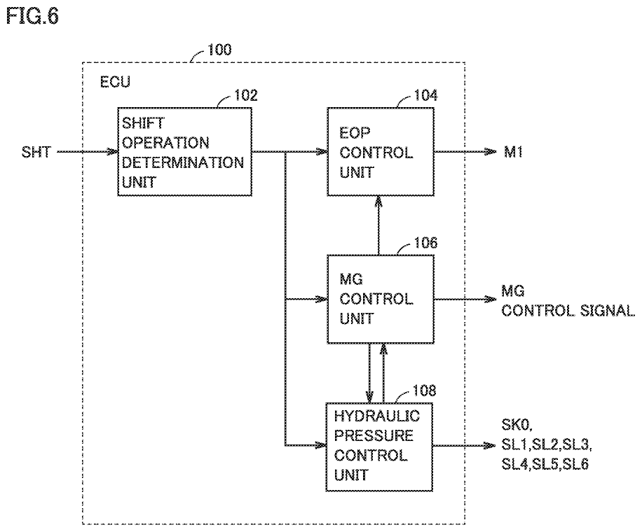

FIG. 6 is a functional block diagram of ECU 100. ECU 100 includes a shift operation determination unit 102, an EOP control unit 104, an MG control unit 106, and a hydraulic pressure control unit 108. These configurations may be implemented by software processing or hardware (or electrical circuitry).

Shift operation determination unit 102 determines a selected shift range based on signal SHT received from shift position sensor 200, Shift operation determination unit 102 determines whether there is a shift corresponding to the first shift pattern or the second shift pattern.

When shift operation determination nit 102 determines that there is a shift corresponding to the first shift pattern, shift operation determination unit 102 outputs a signal indicating that there is a shift corresponding to the first shift pattern (hereinafter also referred to as a “first signal”) to EOP control unit 104, MG control unit 106, and hydraulic pressure control unit 108. The first signal plays a role of a start signal for the first control. More specifically, when shift operation determination unit 102 determines that there is a shift from the N range to the D range, shift operation determination unit 102 outputs a signal (the first signal) indicating that there is a shift from the N range to the D range to EOP control unit 104, MG control unit 106, and hydraulic pressure control unit 108. When shift operation determination unit 102 determines that there is a shift from the N range to the R range, shift operation determination unit 102 outputs a signal (the first signal) indicating that there is a shift from the N range to the R range to EOP control unit 104, MG control unit 106, and hydraulic pressure control unit 108. When shift operation determination unit 102 determines that there is a shift from the P range to the D range, shift operation determination unit 102 outputs a signal (the first signal) indicating that there is a shift from the P range to the D range to EOP control unit 104, MG control unit 106, and hydraulic pressure control unit 108. When shift operation determination unit 102 determines that there is a shift from the P range to the R range, shift operation determination unit 102 outputs a signal (the first signal) indicating that there is a shift from the P range to the R range to EOP control unit 104, MG control unit 106, and hydraulic pressure control unit 108.

When shift operation determination unit 102 determines that there is a shift corresponding to the second shift pattern, shift operation determination unit 102 outputs a signal indicating that there is a shift corresponding to the second shift pattern (hereinafter also referred to as a “second signal”) to EOP control unit 104, MG control unit 106, and hydraulic pressure control unit 108. The second signal plays a role of a start signal for the second control. More specifically, when shift operation determination unit 102 determines that there is a shift from the R range to the D range, shift operation determination unit 102 outputs a signal (the second signal) indicating that there is a shift from the R range to the D range to EOP control unit 104, MG control unit 106, and hydraulic pressure control unit 108. When shift operation determination unit 102 determines that there is a shift from the D range to the R range, shift operation determination unit 102 outputs a signal (the second signal) indicating that there is a shift from the D range to the R range to EOP control unit 104, MG control unit 106, and hydraulic pressure control unit 108.

When EOP control unit 104 receives the first signal or the second signal, EOP control unit 104 outputs control signal M1 to EOP 27. This actuates EOP 27. When EOP control unit 104 receives an end signal for the first control or an end signal for the second control, EOP control unit 104 outputs control signal M1 to EOP 27 to stop EOP 27. Thus, EOP 27 is stopped.

MG control unit 106 outputs an MG control signal to motor generator 22. Specifically, when MG control unit 106 receives the first signal, MG control unit 106 outputs an MG control signal to motor generator 22 for actuating and rotating motor generator 22 at a prescribed rotational speed. When MG control unit 106 receives the second signal, MG control unit 106 outputs an MG control signal to motor generator 22 for decreasing the rotational speed of motor generator 22 to a prescribed rotational speed.

When MG control unit 106 receives from the hydraulic pressure control unit a signal indicating that switching an engagement state of the AT clutch is completed, MG control unit 106 outputs an MG control signal to motor generator 22 for increasing the rotational speed of motor generator 22 to a target rotational speed. Once MG control unit 106 has controlled motor generator 22 to rotate at the target rotational speed, MG control unit 106 outputs an end signal for the first control or the second control to EOP control unit 104.

When hydraulic pressure control unit 108 receives from MG control unit 106 a signal indicating that the rotational speed of motor generator 22 has been set to a prescribed rotational speed, hydraulic pressure control unit 108 switches an engagement state of the AT clutch based on the first signal or the second signal. Specifically, hydraulic pressure control unit 108 outputs signals SL1 to SL6 to first solenoid valve 57 to sixth solenoid valve 62, respectively, depending on the selected shift range.

<Procedure of Process of First Control>

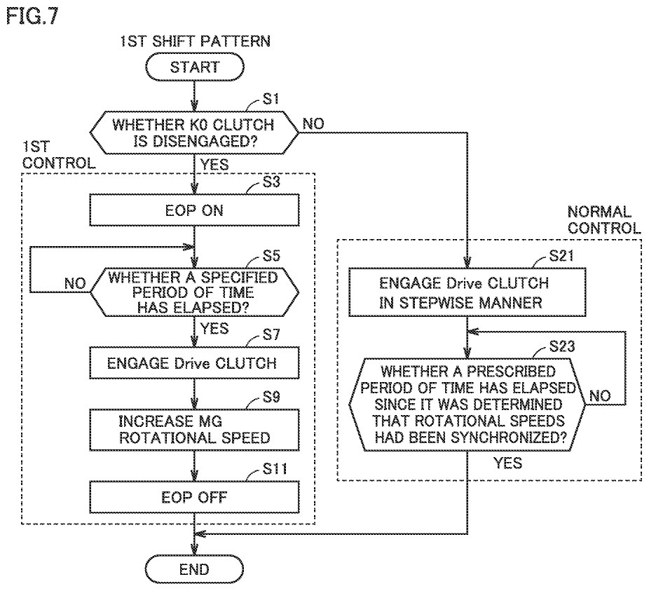

FIG. 7 is a flowchart of a procedure of a process of the first control. The flowchart shown in FIG. 7 is executed by ECU 100 when it is determined that there has been a shift corresponding to the first shift pattern. While each step (hereinafter abbreviated as “S”) of the flowcharts shown in FIG. 7 and FIG. 8 to FIG. 10 described hereinafter is implemented by software processing by ECU 100, it may partially or entirely be implemented by hardware (or electrical circuitry) fabricated in ECU 100.

ECU 100 determines whether K0 clutch 12 is disengaged (S1). In other words, in S1, it is determined whether the traveling mode of hybrid vehicle 1 is the BY mode. When it is determined that K0 clutch 12 is disengaged (YES in S1), ECU 100 executes the first control. Specifically, ECU 100 initially actuates EOP 27 (83). Furthermore, in S3, ECU 100 may actuate EOP 27 and also control motor generator 22 to rotate motor generator 22 at a prescribed rotational speed.

ECU 100 determines whether a specified period of time has elapsed since EOP 27 was actuated (S5). The specified period of time is set as that for starting EOP 27. The specified period of time is set for example to be equal to or longer than a period of time elapsing after the control signal for actuating EOP 27 is transmitted before EOP 27 can supply a line pressure. For example, the specified period of time corresponds to a period of time from time t1 to time t2 in FIG. 6.

When the specified period of time has not elapsed (NO in S5), ECU 100 waits until the specified period of time elapses.

Once the specified period of time has elapsed (YES in S5), ECU 100 engages the Drive clutch (S7).

ECU 100 increases the rotational speed of motor generator 22 to a target rotational speed (S9).

Subsequently, ECU 100 stops EOP 27 (S61) and ends the first control.

On the other hand, when it is determined in S1 that K0 clutch 12 is not disengaged (NO in S1), ECU 100 executes the normal control. Specifically, ECU 100 gradually supplies hydraulic pressure to the Drive clutch to engage the Drive clutch in a stepwise manner (S21).

ECU 100 determines whether a prescribed period of time has elapsed since it was determined that any engagement element included in the Drive clutch had its driving and driven plates rotating with their rotational speeds synchronized (523).

When the prescribed period of time has not elapsed (NO in S23), ECU 101 waits until the prescribed period of time elapses. Once the prescribed period of time has elapsed (YES in S23), ECU 100 ends the process.

<Procedure of Process of Second Control>

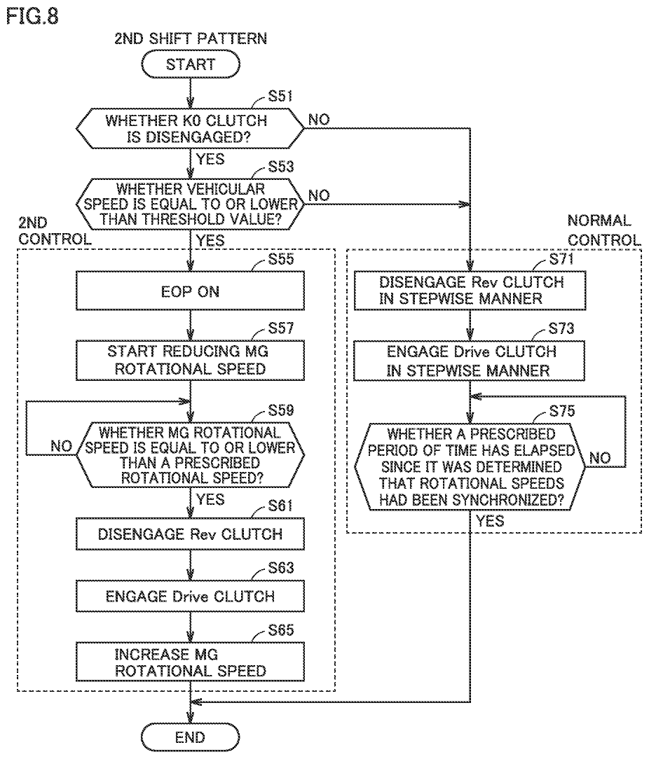

FIG. 8 is a flowchart of a procedure of a process of the second control. The flowchart shown in FIG. 8 is executed by ECU 100 when it is determined that there is a shift corresponding to the second shift pattern.

ECU 100 determines whether K0 clutch 12 is disengaged (S51). In other words, in S51, it is determined whether the traveling mode of hybrid vehicle 1 is the EV mode. When it is determined that K0 clutch 12 is disengaged (YES in S51), ECU 100 determines whether the current vehicular speed is equal to or lower than a threshold value (S53). The step of S53 is a step for determining whether there is a possibility of generating a shock by executing the second control. Some drivers may operate the shift lever before hybrid vehicle 1 is completely stopped (that is, the vehicular speed is not zero). When hybrid vehicle 1 is traveling at a vehicular speed equal to or higher than the threshold value, and the second control is executed and motor generator 22 has a rotational speed reduced to a prescribed rotational speed, there is a possibility that a shock accompanying the change in the rotational speed may be caused. In such a case, it is desirable to avoid the second control, and execute the normal control to shift gears. The threshold value is set for example to a vehicular speed for which the input shaft of automatic transmission 23 rotates at the first rotational speed.

When it is determined that the vehicular speed is equal to or lower than the threshold value (YES in S53), ECU 100 executes the second control. Specifically, ECU 100 initially actuates EOP 27 (S55).

Subsequently, ECU 100 reduces the rotational speed of motor generator 22 to a prescribed rotational speed (S57).

ECU 100 determines whether the rotational speed of motor generator 22 has been reduced to the prescribed rotational speed (559). When the rotational speed of motor generator 22 has not been reduced to the prescribed rotational speed (NO in S59), ECU 100 waits until the rotational speed of motor generator 22 is reduced to the prescribed rotational speed.

Once the rotational speed of motor generator 22 has been reduced to the prescribed rotational speed (YES in S59), ECU 100 disengages the Rev clutch (S61).

Subsequently, ECU 100 engages the Drive clutch (S63). When switching is completed in an engagement state of the AT clutch (S61, S63), ECU 100 increases the MG rotational speed to a target rotational speed.

On the other hand, when it is determined in S51 that K0 clutch 12 is not disengaged (NO in S51), ECU 100 executes the normal control. When it is determined in S53 that the vehicular speed is not equal to or lower than the threshold value (NO in S53), ECU 100 executes the normal control. Specifically, initially, ECU 100 gradually decreases hydraulic pressure supplied to the Rev clutch and thus disengages the Rev clutch in a stepwise manner (S71).

Subsequently, ECU 100 gradually supplies hydraulic pressure to the Drive clutch to engage the Drive clutch in a stepwise manner (S73).

In the steps of S71 and S73, only an engagement element that needs to be switched may be disengaged and engaged depending on the second shift pattern. Specifically, in accordance with the second shift pattern, only an engagement element of the Rev clutch that needs to be disengaged may be disengaged in S71, and only an engagement element of the Drive clutch that is unengaged may be engaged in S73.

ECU 100 determines whether a prescribed period of time has elapsed since it was determined that any engagement element included in the Drive clutch had its driving and driven plates rotating with their rotational speeds synchronized (S75).

When the prescribed period of time has not elapsed (NO in S75), ECU 100 waits until the prescribed period of time elapses. Once the prescribed period of time has elapsed (YES in S75), ECU 100 ends the process.

Thus, in the present embodiment, when a shift is made in the first shift pattern and the second shift pattern, the AT clutch has an engagement state switched while motor generator 22 has a rotational speed set to a prescribed rotational speed. Since motor generator 22 rotates at a low speed, occurrence of a shift shock can be suppressed even when the AT clutch is rapidly engaged and disengaged. Accordingly, the AT clutch can be rapidly engaged and disengaged, and when this is compared with a case where the AT clutch is engaged and disengaged while hydraulic pressure supplied to the AT clutch is gradually changed in order to suppress a shift shock caused as the AT clutch's engagement state is switched (i.e., normal control), the former can reduce a period of time required for shifting gears.

(Variation)

Some driver may depress the accelerator pedal simultaneously with a change of a shift range. Depending on by how much amount the accelerator pedal is depressed, it may be necessary to actuate engine 10. In such a case, it is desired that changing the shift range and actuating engine 10 be quickly performed.

In hybrid vehicle 1 according to a variation, when a shift is made in the first shift pattern or the second shift pattern and simultaneously engine 10 needs to be actuated, ECU 100 engages K0 clutch 12 while setting motor generator 22 to rotate at a prescribed rotational speed. And ECU 100 switches an engagement state of the AT clutch to increase the rotational speed of motor generator 22 to a target rotational speed. That is, in the variation, K0 clutch 12 is engaged under the first control and the second control. K0 clutch 12 can be engaged while motor generator 22 has a low rotational speed, that is, while the input shaft of automatic transmission 23 has a low rotational speed, and a shock caused by engagement can be suppressed even when K0 clutch 12 is supplied with an engaging hydraulic pressure at once. Changing a shift range and actuating engine 10 can thus be performed quickly.

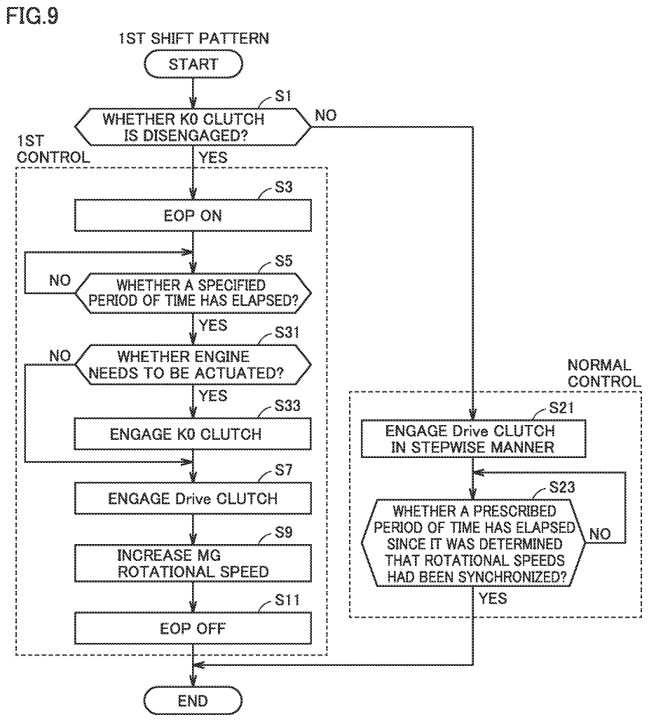

FIG. 9 is a flowchart of a procedure of a process of the first control in a variation. The flowchart of FIG. 9 corresponds to that of FIG. 7 plus S31 and S33. The remainder is the same as that in the flowchart of FIG. 7 and accordingly, will not be described repeatedly.

When it is determined that K0 clutch 12 is disengaged (YES in S1), ECU 100 executes the first control. ECU 100 actuates EOP 27 (S3), and waits until a specified period of time elapses.

Once the specified period of time has elapsed (YES in S5), ECU 100 determines whether it is necessary to actuate engine 10 (S31). When. ECU 100 determines that it is necessary to actuate engine 10 (YES in S31), ECU 100 engages K0 clutch 12 (S33). On the other hand, when ECU 100 determines that it is unnecessary to actuate engine 10 (NO in S31), ECU 100 skips 833 and proceeds to S7.

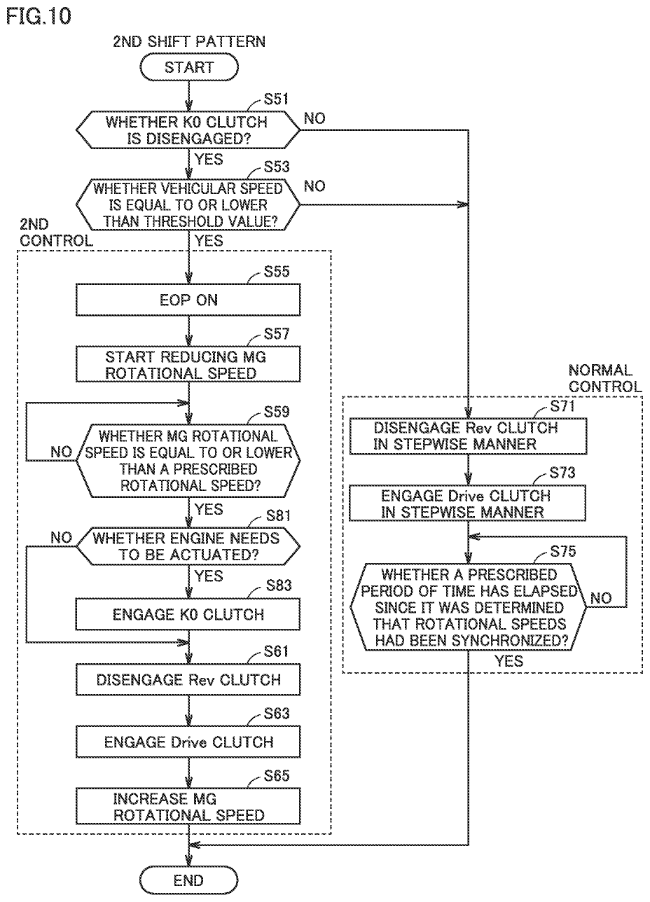

FIG. 10 is a flowchart of a procedure of a process of the second control in a variation. The flowchart of FIG. 10 corresponds to the flowchart of FIG. 8 plus S81 and S83. The remainder is the same as that in the flowchart of FIG. 8, and accordingly, will not be described repeatedly.

When K0 clutch 12 is disengaged (YES in S51) and it is determined that the vehicular speed is equal to or lower than a threshold value (YES in S53), ECU 100 executes the second control. ECU 100 actuates EOP 27 (S55), and reduces the rotational speed of motor generator 22 to a prescribed rotational speed (S57).

Once the rotational speed of motor generator 22 has been reduced to the prescribed rotational speed (YES in S59), ECU 100 determines whether it is necessary to actuate engine 10 (S81). When ECU 100 determines that it is necessary to actuate engine 10 (YES in S81), ECU 100 engages K0 clutch 12 (S83). On the other hand, when ECU 100 determines that it is unnecessary to actuate engine 10 (NO in S31), ECU 100 skips S83 and proceeds to S61.

It should be understood that the presently disclosed embodiments are illustrative and not restrictive in any respect. The scope of the present invention is defined by the terms of the claims and intended to encompass any modifications within a meaning and scope equivalent to the terms of the claims.

What is claimed is:

1. A drive device for a hybrid vehicle, comprising:
an internal combustion engine;
an electric motor;
an automatic transmission that transmits power of at least one of the internal combustion engine and the electric motor to a driving wheel;
a first engagement element provided between the internal combustion engine and the electric motor;
an electrically driven hydraulic pressure source that supplies hydraulic pressure to the first engagement element and engagement elements included in the automatic transmission; and
a control device that controls the electric motor and the electrically driven hydraulic pressure source, wherein
when the automatic transmission has a shift range changed and the first engagement element is disengaged, the control device executes a prescribed control, and
in the prescribed control, the control device
sets a rotational speed of the electric motor to be equal to or lower than a prescribed rotational speed,
switches an engagement state of the engagement elements included in the automatic transmission to an engagement state corresponding to the changed shift range, and
increases the rotational speed of the electric motor to a target rotational speed corresponding to the changed shift range.

2. The drive device for a hybrid vehicle according to claim 1, wherein
the control device stops the electric motor when the shift range of the automatic transmission is a neutral range or a parking range,
the control device executes a first control as the prescribed control when the shift range of the automatic transmission is changed from the neutral range or the parking range to a forward drive range or a reverse drive range and the first engagement element is disengaged, and
in the first control, the control device
continues to stop the electric motor,
switches an engagement state of the engagement elements included in the automatic transmission to an engagement state corresponding to the changed shift range, and
increases a rotational speed of the electric motor to the target rotational speed.

3. The drive device for a hybrid vehicle according to claim 1, further comprising a mechanically driven hydraulic pressure source that operates using the internal combustion engine or the electric motor as a power source, wherein
the control device stops the electric motor when the shift range of the automatic transmission is a neutral range or a parking range,
the control device executes a first control as the prescribed control when the shift range of the automatic transmission is changed from the neutral range or the parking range to a forward drive range or a reverse drive range and the first engagement element is disengaged, and
in the first control, the control device
increases a rotational speed of the electric motor to the prescribed rotational speed,
switches an engagement state of the engagement elements included in the automatic transmission to an engagement state corresponding to the changed shift range, and
increases the rotational speed of the electric motor to the target rotational speed.

4. The drive device for a hybrid vehicle according to claim 2, wherein the control device does not execute the first control when the shift range of the automatic transmission is changed from the neutral range or the parking range to the forward drive range or the reverse drive range and the first engagement element is not disengaged.

5. The drive device for a hybrid vehicle according to claim 1, wherein
when the shift range of the automatic transmission is a forward drive range or a reverse drive range and an accelerator pedal is not operated, the control device causes the electric motor to rotate at a target rotational speed corresponding to the selected shift range,
when the shift range of the automatic transmission is changed between the forward drive range and the reverse drive range and the first engagement element is disengaged, the control device executes a second control as the prescribed control, and
in the second control, the control device
reduces the rotational speed of the electric motor to the prescribed rotational speed,
switches an engagement state of the engagement elements included in the automatic transmission to an engagement state corresponding to the changed shift range, and
increases the rotational speed of the electric motor to the target rotational speed.

6. The drive device for a hybrid vehicle according to claim 5, wherein the control device does not execute the second control when the shift range of the automatic transmission is changed between the forward drive range and the reverse drive range and the first engagement element is not disengaged.

7. The drive device for a hybrid vehicle according to claim 5, wherein the control device does not execute the second control when the hybrid vehicle has a vehicular speed larger than a threshold value.

8. The drive device fir a hybrid vehicle according to claim 1, wherein when the shift range of the automatic transmission is changed, the first engagement element is disengaged, and the internal combustion engine is actuated after the shift range is changed, the control device
sets a rotational speed of the electric motor to be equal to or lower than a prescribed rotational speed,
engages the first engagement element,
switches an engagement state of the engagement elements included in the automatic transmission to an engagement state corresponding to the changed shift range, and
increases the rotational speed of the electric motor to a target rotational speed corresponding to the changed shift range.
